(19) United States
(12) Patent Application Publication
(10) Pub. No.: US 2005/0167407 A1
(43) Pub. Date: Aug. 4, 2005

(54) Process and apparatus for joining components using laser radiation

(76) Inventors: Jie-Wei Chen, Alpnach Dorf (CH); Christiane Leister, Wilan/Obwalden (CH)

Correspondence Address: BACHMAN & LAPOINTE, P.C., 900 CHAPEL STREET, SUITE 1201, NEW HAVEN, CT, 06510, US

(21) Appl. No.: 10/946,143

(22) Filed: Sep. 20, 2004

(30) Foreign Application Priority Data
Sep. 20, 2003 (EP) 03021344.1

(51) Int. Cl. B23K 26/20; B23K 26/06

(52) U.S. Cl. 219/121.64; 219/121.74

(57) ABSTRACT

Process and apparatus for joining components, in particular plastic components, by laser beams using a transmission welding process. To ensure that the laser beams are simultaneously introduced into the region of the joint seam even in the case of relatively large components, a clamping element is provided. The clamping element includes devices for diverting the laser beam onto the joint seam. In addition, there is a clamping part which is matched to the shape of the components and is transparent to the laser beam, by which clamping part the components are pressed together and the laser beam is introduced into the region of the joint seam. This allows a scanner process to be used without restriction for all possible components in particular in the case of simultaneous welding. The process can also be used to solder connections for electronic components.

### BACKGROUND OF THE INVENTION

Process for joining components, in particular plastic components, or also for soldering connections of electronic components, by means of laser beams, in which a laser beam is generated and is diverted from an illumination device, quasi-simultaneously, onto the locations that are to be joined, in accordance with the joining contour. The invention also relates to an apparatus for joining components, in particular plastic components, by laser beams by means of a laser source and an illumination device for the shaping and targeted diversion the laser beam quasi-simultaneously, onto the locations that are to be joined, and a pressing-together device for the components at least in the region that is to be joined.

The joining of plastic components by means of laser beams in the IR region, in particular, using the transmission welding process, is generally known. In this process, the components are joined to one another in such a manner that a first part which is transparent to the laser radiation and faces the laser source, is arranged on a component which absorbs the laser radiation, is heated at the contact surface, so that the two components melt where the heating has occurred and are joined under the simultaneous application of pressure. For this purpose, it is also known to use a scanner to move a punctiform laser beam over defined regions of the components that are to be joined to one another. In the most simple form, this is usually effected using a moving scanner mirror. Given sufficiently fast movement, it is for this purpose possible to realize virtually simultaneous joining of components in the desired regions. It is also possible to provide the laser beam with a suitable weld line contour, so that heating is not punctiform, but rather takes place along a line or an area, and this region is welded simultaneously. This is of importance in particular for manufacturing technology reasons in terms of the time required for the welding. In this context, it is in particular also advantageous that sufficient welding can be achieved using just one laser source. The present text uses the term illumination device as a term to describe the combination of the laser beam shaping and diverting. This illumination device includes suitable known optical systems for beam shaping and movement.

This process causes problems if large-volume parts or complicated parts are to be welded to one another, these parts, by way of example, additionally having a flange for the welding, along which the two components are to be welded to one another. In this case, with a scanner system of this type, the laser beam does not impinge as vertically as possible on the components to be joined throughout, or the locations to be joined are in the beam shadow, since the laser beam is always diverted from one point.

Corresponding problems also occur when soldering the connections of relatively large electronic components, in which the connections are not directly accessible to the laser beam.

### SUMMARY OF THE INVENTION

Therefore, the present invention is based on the object of proposing a possible way of compensating for the shadow effect resulting from the beam angle in order to widen the range of applications of the scanner process.

According to the invention, this object is achieved by a process having the features of claim 1 and by an apparatus having the features of the independent apparatus claims. Further advantageous configurations are given in the subclaims referring back to the respective independent claims.

According to the invention, this is achieved by virtue of the fact that an additional diverter device is arranged between the illumination device and the components, and the laser beam which has been diverted onto the diverter device from the illumination device is diverted toward locations at the components which cannot be reached directly from the illumination device. This makes it possible to avoid shadow effects and to achieve favorable heating angles with the minimum possible energy. The diversion may also be effected by reflective, substantially stationary surfaces or also, for example, by moving mirrors, micro-optical components, micro-optically structured foils. These may be integrated in a pressing-together device or may also be arranged outside it.

For this purpose, according to one preferred implementation, the laser beam is diverted onto the locations that are to be joined via a diverter device which is of component-specific design. This diverter device is designed and adapted according to the shape of the components that are to be joined to one another, so that as far as possible all the locations for heating are supplied with sufficient energy at all times, preferably simultaneously.

It is advantageous for the laser beam, in particular for the welding of plastics, to be diverted onto the locations that are to be joined via a diverter device which is integrated in a pressing-together device. This diverter device may be formed by reflective stationary surfaces or moving mirrors. It is preferable for the laser beams to be diverted onto the locations that are to be joined via a diverter device which is arranged in a first clamping element, facing the laser source, of the pressing-together device, the laser beams particularly preferably being passed through a clamping part which is arranged in the clamping element and is transparent to the laser beams. This clamping part then simultaneously serves to apply the contact pressure to the components that are to be joined to one another, the clamping part being of component-specific design and having an inner cavity which corresponds to the component and in which there is space for the component. Moreover, surfaces for the pressure to be applied to are also made available.

In the clamping device, the inclination of the reflective surfaces is adapted to their position with respect to the component, it being possible for the inclination to be set variably within a clamping device. It is preferable for the first clamping element to be designed as a clamping frame which presses the clamping part which is transparent to the laser radiation onto the component which faces the laser beam. In this case, it is expedient for the side facing the laser source to be coated with an antireflection surface in order as far as possible to collect all the incident laser radiations. Moreover, it is expedient for the side wall of the clamping element to be provided with a reflective surface, so that the laser beams which penetrate through the side facing the illumination device do not escape at the sides and at the surface are reflected directly onto the locations that are to be welded. If the external contour of the clamping element is designed to be round, optimum irradiation can be effected. Depending on the design of the components, it may also adopt other forms, for example polygonal forms. Both quartz glass and transparent plastics can be used as material for the clamping part. At least this clamping part, and if appropriate also the clamping frame, are accurately matched to the requirements of the welding and the component and are suitably shaped or designed, for example by means of a CAD system. For mass production, this additional outlay is economically advantageous, since it enables the scanner process to continue to be used without restriction for all possible components, in particular for simultaneous welding.

### BRIEF DESCRIPTION OF THE DRAWINGS

The invention is explained in more detail below on the basis of an exemplary embodiment, in which:

FIG. 1 shows a sectional illustration of the structure in a pressing-together device, and

FIG. 2 shows an outline illustration with differently arranged reflection surfaces.

### DETAILED DESCRIPTION OF THE PREFERRED EMBODIMENT(S)

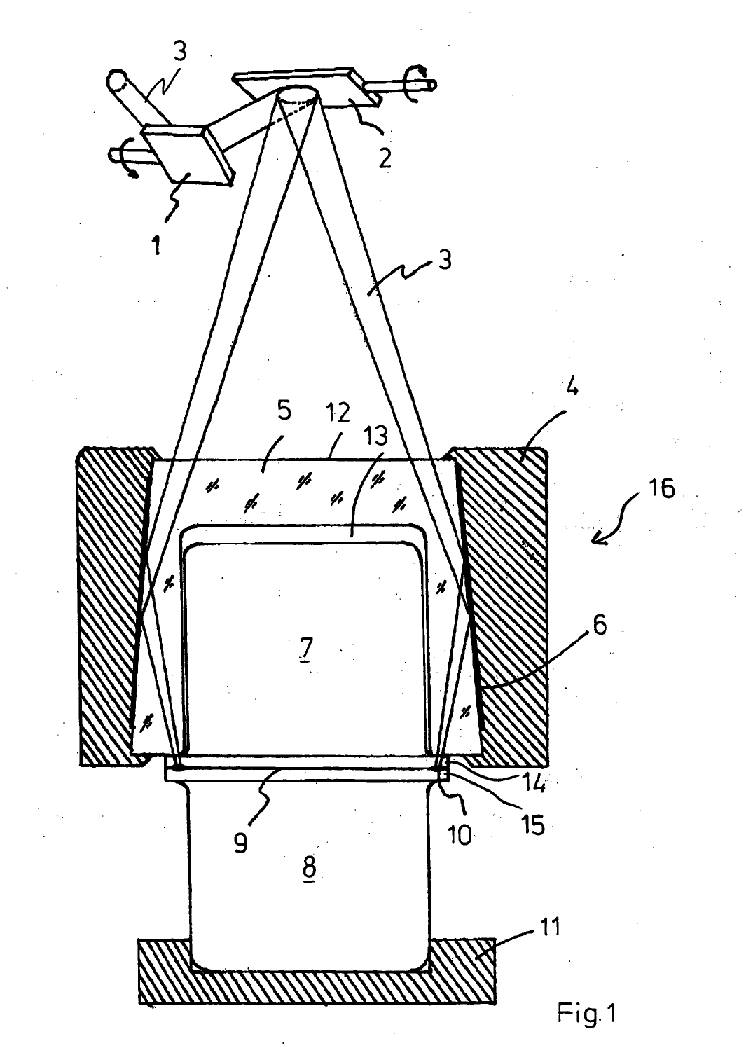

In accordance with FIG. 1, via a first scanner mirror 1, which can rotate about an axis, and a second scanner mirror 2, which can rotate about an axis, the laser beam 3, which impinges on these scanner mirrors 1, 2 in suitable form (this arrangement overall forming the illumination device), in this example in round form, is diverted toward the components 7 and 8 which are to be joined to one another. The components 7 and 8 are held in a clamping device which comprises an upper holding element, in the form of the metallic clamping frame 4, and a lower holding plate 11. The metallic clamping frame 4 holds a clamping part 5 which is transparent to the laser radiation and is designed to match the overall shape of the upper component 7. For this purpose, it has a suitable receiving cavity 13, in which there is space for the component 7 and which is designed in such a way that it is supported on the flange 14. Accordingly, in the exemplary embodiment the lower component 8 has an associated flange 15. The joining plane 9 is located between this flange, so that a peripherally encircling joint seam 10 can be produced by means of the laser beam 3. For this purpose, the laser beam 3 passes through that surface of the clamping part 5 which has been provided with an antireflection coating 12 onto the mirror coating 6 which has been applied to the outside of the clamping part 5 and reflects the incident laser beam toward the joint seam 10 with the minimum possible loss. That surface in the clamping part 5 which has been provided with the mirror coating 6 has a suitable inclination as a function of the geometric configurations. Therefore, the laser beam 3 simultaneously passes with sufficient intensity onto the location that is to be welded, so that rapid welding can also be realized using an illumination device.

In the exemplary embodiment, at least the clamping part 5 is designed to be round in terms of its regions which are active for the laser beams 3.

The production of the clamping part 5 may, for example, be simulated and defined by a CAD system together with the dimensioning of the components 7, 8, the scanner parameters and the desired incident beam angles.

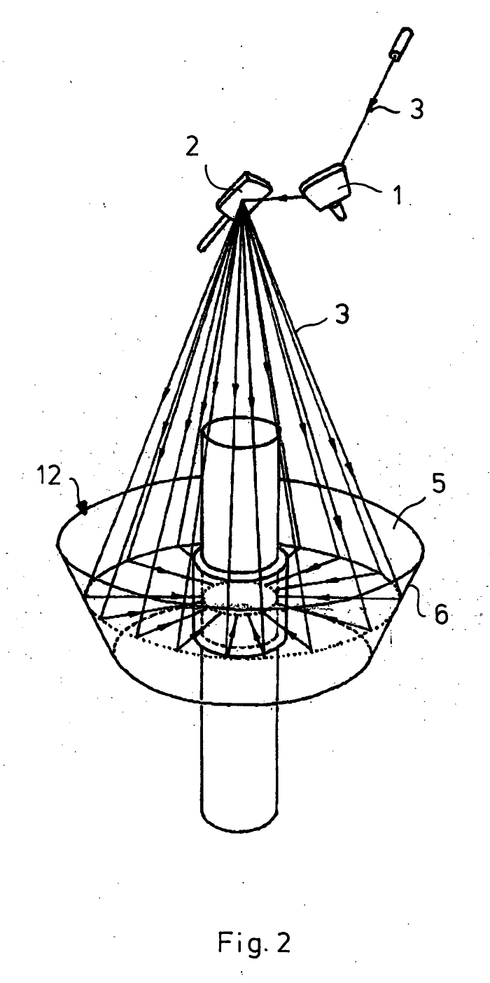

FIG. 2 shows a different inclination of the reflective surfaces which are arranged in the pressing-together device in order, for example, to weld a flexible tube.

1. A process for joining components by means of laser beams comprising generating and diverting a laser beam from an illumination unit quasi-simultaneously onto locations that are to be joined in accordance with a joining contour, arranging an additional diverter device between the illumination unit and the components and diverting the laser beams onto the additional diverter device from the illumination unit toward the locations at the components which cannot be reached directly from the illumination unit.

2. The process as claimed in claim 1, wherein the diverting step comprises diverting the laser beams onto the locations that are to be joined via the diverter device which is of a component-specific design.

3. The process as claimed in claim 1, wherein the diverting step comprises diverting the laser beams onto the locations that are to be joined via the diverter device which is integrated in a pressing-together device.

4. The process as claimed in claim 3, wherein the diverting step further comprises diverting the laser beams onto the locations that are to be joined via a clamping element which is arranged in a first diverter device facing a laser source of the pressing-together device.

5. The process as claimed in claim 4, wherein the diverting step further comprises diverting the laser beams by means of fixed or movable reflective surfaces in the clamping element.

6. The process as claimed in claim 4, further comprising passing the laser beams through a clamping part which is arranged in the clamping element and is transparent to the laser wavelength.

7. The process as claimed in claim 6, further comprising matching the clamping part to the shape of the components that are to be joined.

8. The process as claimed in claim 1, wherein the diverting step comprises diverting the laser beams onto all of the locations that are to be joined simultaneously.

9. An apparatus for joining components by laser beams by means of a laser source and an illumination device for the shaping and targeted diversion of the laser beams quasi-simultaneously onto locations that are to be joined, and a pressing-together device for the components at least in a region that is to be joined, and devices for diverting the laser beams coming from the illumination device onto the locations that are to be joined but are not accessible to the laser beams direct from the illumination device, said diverting devices being arranged in the pressing-together device.

10. The apparatus as claimed in claim 9, wherein the devices for diverting the laser beams are arranged in a first clamping element, facing the laser source, of the pressing-together device, by means of which first clamping element, together with a second clamping element, the components situated between the first and second clamping elements can be pressed together.

11. The apparatus as claimed in claim 10, wherein the first clamping element has reflective surfaces, the inclination of which is matched to the components that are to be joined to one another.

12. The apparatus as claimed in claim 11, wherein the first clamping element is designed as a clamping frame which presses a clamping part that is transparent to the laser radiation onto one of the components.

13. The apparatus as claimed in claim 12, wherein that side of the clamping part which faces the laser source is provided with an antireflection coating.
